(19) United States
(12) Patent Application Publication
(10) Pub. No.: US 2010/0021679 A1
(43) Pub. Date: Jan. 28, 2010

(54) Polyamide yarns, filaments and fibers having enhanced properties

(76) Inventor: Gilles Robert, Irigny (FR)

Correspondence Address: BUCHANAN, INGERSOLL & ROONEY PC, POST OFFICE BOX 1404, ALEXANDRIA, VA, 22313-1404, US

(21) Appl. No.: 11/921,906

(22) PCT Filed: Jun. 9, 2006
(86) PCT No.: PCT/FR2006/001309

§ 371 Date: Jul. 17, 2009

(30) Foreign Application Priority Data
Jun. 10, 2005 (FR) 0505915

(51) Int. Cl. D01F 1/10; D02G 3/00; B29C 47/00; D04H 1/08; D04H 11/00; D03D 27/00; D03D 15/00; D04G 1/00; C08K 3/22; C08K 3/30; C08K 3/34; C08K 3/32

(52) U.S. Cl. 428/87; 428/372; 264/176.1; 442/320; 442/181; 442/1; 524/449; 524/430; 524/414; 524/418; 524/445; 524/413

(57) ABSTRACT

Polyamide yarns, filaments and fibers in which nanoparticles are dispersed, process for the preparation thereof and applications of these.

The present invention relates to synthetic filaments, fibres and yarns, particularly based on a polyamide, possessing improved mechanical properties and especially improved elongation and improved crush strength (transverse yield).

The present invention also relates to a process for spinning said filaments and to the use of said filaments, fibres and yarns in various fields, especially in processes involving filtration, pressing or dewatering operations. One particularly appropriate use is that of felts for a paper machine (or paper felt).

Polyamide fibres having improved mechanical properties are already widely known. In particular, Patent Application WO 99/60057 discloses polyamide-based matrices in which delaminated silicate nanoparticles are dispersed. Likewise, international application WO 01/12678 describes a process for preparing polyamides containing dissociated silicates.

Japanese Patent Application JP-B2-2716810 teaches that polyamide filaments containing 0.05 to 30 parts by weight of silicates, for example a multilayer clay, possess excellent mechanical properties, such as tenacity, elongation, strength, drawing and other properties.

However, there still exists a need for polyamide fibres, yarns or filaments possessing further improved properties.

Thus, a first objective of the present invention consists in providing polyamide filaments, fibres and yarns having a high elongation at break.

A second objective of the present invention is defined by polyamide filaments, fibres and yarns having a high elongation at break and a high transverse yield strength.

Another objective of the present invention consists in providing polyamide filaments, fibres and yarns having a high elongation at break and a high transverse yield strength and containing only a relatively small amount of nanoparticles.

Another objective of the present invention is to propose polyamide filaments, fibres and yarns having a high elongation at break and a high transverse yield strength, while containing only a relatively small amount of nanoparticles and having, for a given elongation, a higher strength than the known filaments, fibres or yarns of the prior art.

Yet other objectives will become apparent in the description of the invention that follows.

According to a first aspect, the present invention relates to filaments, fibres, and yarns comprising a polyamide matrix in which between 0.01% and 5% by weight, preferably between 0.02% and 3% by weight, and more preferably between 0.05% and 2% by weight of nanoparticles are dispersed and having a transverse yield strength of between 40 and 150 MPa, preferably between 45 and 95 MPa, with an elongation at break of between 20% and 140%, advantageously between 40% and 100%, for a relative humidity of 50%, at 23° C.

The polyamide matrix from which the yarns, fibres and filaments of the invention are manufactured comprises any type of polyamide known per se, and in particular any polyamide normally used in the field of textile articles or yarns, fibres, etc. for high-performance applications.

Although not constituting a limitation of the present invention, the matrix of the yarns, fibres and filaments is a polyamide or copolyamide or else a blend of polyamides, the weight-average molecular weight of which is between 25 000 g/mol and 100 000 g/mol, preferably between 30 000 g/mol and 90 000 g/mol, advantageously between 40 000 g/mol and 85 000 g/mol.

By way of non-limiting example, the polyamides that may be used in the present invention comprise nylon-6,6, nylon-6, nylon-6/6,6 copolymer, semi-aromatic polyamides, such as the polyamide 6T, Amodel® (sold by Amoco), HTN® (sold by DuPont), and other polyamides such as nylon-11, nylon-12, nylon-4-6, and others, and also blends thereof in any proportions.

The polyamides may be of linear or branched structure, such as for example the star polyamide sold be Rhodia under the brand name Technylstar®.

For the requirements of the invention, it is preferred to use nylon-6,6 or nylon-6, or else nylon-6/6,6 copolymer, by themselves or as blends in any proportions of two or more of them.

The yarns, fibres and filaments according to the invention are obtained by melt-spinning a filled composition, as will be explained later in the present description.

Moreover, any conventional step in the field of the manufacture of yarns, fibres and filaments, which is intended for example for dimensionally stabilizing (thermosetting) the yarns, fibres and filaments, or else for giving them bulk by passing through a stuffing (crimping) box may be applied. Any other process for manufacturing yarns, fibres and filaments may also be suitable.

The yarns, fibres and filaments that can be used in the present invention may have cross sections of any shape, whether round, flat, serrate or fluted, or else in the form of a kidney bean, but also multilobate, in particular trilobate or pentalobate, in the form of an X, or taped, hollow, square, triangular, elliptical and other shapes.

However, their cross-sectional shape is not an essential feature of the invention. All cross-sectional shapes resulting from the process for manufacturing said yarns, fibres and filaments are acceptable. Likewise, the yarns, fibres and filaments used in the present invention may be of constant diameter and/or constant cross section or may exhibit variations.

Finally, the expression “polyamide yarns, fibres and filaments according to the invention” should be understood to mean in general spun articles, for example multicomponent yarns, fibres and filaments (for example of the “core-shell” type) at least one of the components of which is a polyamide as defined above.

The term “yarn” is understood to mean a monofilament, a continuous multifilament yarn, or staple fibre yarn, obtained from a single fibre type or from several intimately blended fibre types. The continuous yarn may also be obtained by assembling several multifilament yarns. The term “fibre” is understood to mean a filament or assembly of chopped, cracked or converted filaments.

In general, the yarns, fibres and filaments of the present invention are characterized by their strand linear density, which is generally greater than 1.9 decitex (i.e. greater than 1.9 g/10 000 metres) but not exceeding 130 decitex (dtex), advantageously not exceeding 100 dtex. Preferably, the linear density of the yarns, fibres and filaments of the invention will be between 1.9 and 100 dtex, and more preferably between 1.9 and 66 dtex.

The term “nanoparticles” is understood within the context of the present invention to mean fillers with an aspect ratio of not less than 3, preferably between 4 and 1000, limits inclusive, and more preferably between 5 and 500, limits inclusive. Within the context of the present invention, at least one of the dimensions of the nanoparticles is of the order of one nanometre to a few tens of nanometres. The nanoparticles may be in individual form or in the form of agglomerates.

According to one advantageous embodiment of the present invention, the nanoparticles dispersed in the polyamide matrix possess an aspect ratio of between 4 and 1000, limits inclusive, and the smallest particle dimension is 100 nm or less, or less, preferably 75 nm or less, and advantageously 50 nm or less.

The minimum value of the smallest dimension is not important per se. However, a minimum value of the smallest dimension of less than one nanometre is not very appropriate.

The amount of nanoparticles present in the yarns, fibres and filaments according to the present invention is generally between 0.01% and 5% by weight, preferably between 0.02% and 3% by weight, and more preferably between 0.05% and 2% by weight.

Within the context of the present invention, the suitable nanoparticles are reinforcing fillers, preferably in the form of lamellae, of any type known per se and advantageously they are chosen from those commonly used in the field of polyamide fibre, filament or yarn reinforcement.

In particular, any mineral particle possessing the feature of being in the form of lamellar particles can be used within the context of the present invention, and in this regard mention may, in particular, be made of certain oxides, sulphides or phosphates of metals or non-metals, such as titanium, cerium, silicon, zirconium, cadmium and zinc, preferably zirconium phosphate.

The mineral particles may be used as such or else in “intercalated” form, that is to say those that have been subjected to the action of at least one mineral and/or organic intercalation agent.

It should be understood that blends of the various particles or fillers listed above may be used in any proportion.

As examples, said particles may be mineral particles, such as phyllosilicates of the mica type, in particular including clays, smectite clays, swelling smectite clays, including in particular:
variable-interlayer spacing dioctahedral smectite clays such as montmorillonites (comprising askanite, confolensite, erinite, galapectite, malthacite and other synonyms of the term montmorillonite, corresponding among others to minor replacements of structural cations), beidellites (comprising chromebeidellite, ferribeidellite, ferromontmorillonite, glaserite, nontronite, protonontronite, volkonskoite and other clays bearing a name synonymous with the generic name beidellite), and also their corresponding forms bearing a brand name, including in particular and non-exhaustively, amargosites, cloisites, bentonites, otaylites, etc.; and
variable-interlayer spacing trioctahedral smectite clays such as stevensites (including ghassoulite), hectorites (including the corresponding synthetic clay, namely laponite), saponites (comprising bowlingites, sauconites, griffithites and synonyms of these terms, corresponding inter alia to minor replacements of structural cations such as ferrisaponites, lembergites, and other cardenites), vermiculites (including batavite, and other clay synonyms of the vermiculite family, such as culsageeite, kerrite, lennilite, hallite, philadelphite, vaalite, maconite, etc.), and also, finally, their corresponding forms bearing a brand name.

Mention may also be made of illites, sepiollites, palygorskites, muscovites, allevardites, amesites, talcs, fluorohectorites, stevensites, micas, fluoromicas, vermiculites, fluorovermiculites and halloysites.

These clays all possess the feature of being materials comprising agglomerations of lamellar particles stacked to a greater or lesser extent on one another.

Advantageously, the nanoparticles are lamellar particles that may be considered as sheets stacked on one another forming compact stacks, called tactoids. These tactoids may or may not be intercalated, and then, optionally, partially or completely exfoliated (or swollen) using conventional techniques known to those skilled in the art, especially by means of mineral or organic swelling agents, for example mineral bases, such as sodium hydroxide, or organic bases such as hexamethylenediamine, or caprolactam.

According to one embodiment of the present invention, the nanoparticles are zirconium phosphate particles, by themselves or combined with other fillers, for example, such as those mentioned above. The zirconium phosphate may be in various crystalline forms, especially in the “alpha” crystalline form or the “gamma” crystalline form, denoted by “α-ZrP” and “γ-ZrP” respectively in the rest of the present description. The zirconium phosphate and its various crystalline forms that can be used within the context of the present invention are, for example, described in Patent Applications WO-A-2003/070818 and WO-A-2004/096903, the contents of which are incorporated here by reference.

The “alpha” crystalline form of zirconium phosphate, whether intercalated or not, but preferably intercalated, as described for example in Patent Application WO-A-2002/16264, the content of which is also incorporated here by reference, is more particularly preferred.

According to a very preferable embodiment, the yarns, fibres and filaments according to the invention comprise a polyamide matrix in which between 0.01 and 1% by weight, preferably between 0.01 and 0.5% by weight, of zirconium phosphate nanoparticles are dispersed, these preferably being in the α (“α-ZrP”) crystalline form, is as described in Patent Application WO-A-2002/16264.

The spun articles—yarns, fibres and filaments according to the present invention—have very advantageous mechanical properties and especially a very advantageous transverse yield strength of greater than 40 MPa. The term “transverse yield strength” is understood to mean the transverse compressive strength, as indicated in the illustrative examples of the present invention that will appear in the rest of this description.

Furthermore, the yarns, fibres and filaments of the present invention possess a high tenacity, generally between 30 and 85 cN/tex, more particularly between 35 and 75 cN/tex.

The remarkable properties of the yarns, filaments and fibres described above are especially obtained by a particular spinning process defined below, this process representing another subject of the present invention.

Thus, the present invention also relates to a process for producing yarns, fibres and filaments by melt-spinning a filled composition comprising at least one polyamide matrix in which between 0.01 and 5% by weight, preferably between 0.02 and 3% by weight, and more preferably between 0.05% and 2% by weight of nanoparticles are dispersed, said process being characterized in that the take-up rate/extrusion rate ratio is between 20 and 300, preferably between 30 and 200, and more preferably between 40 and 180, for example between 50 and 90.

The polyamide used is as defined above in the present description. The nanoparticles are also as defined above. The nanoparticles may be incorporated in the matrix by introducing them into the polymerization medium, that is to say into the monomer or monomers, before the polymerization reaction, or else incorporated into the polymer matrix by introducing them into the molten polymer, for example by means of a masterbatch.

The expression “melt-spinning a filled composition” corresponds to the melt-spinning technique known to those skilled in the art in which a polymer composition, here the polyamide matrix filled with nanoparticles, is melted and then extruded at a controlled extrusion rate through a spinneret in order to form yarns, fibres and filaments. On exiting the spinneret, the yarns, fibres and filaments are possibly cooled, using conventional (air or water) techniques, and taken up onto a take-up roll at what is called the take-up rate.

The take-up rate is generally between 150 minute and 2000 m/minute, preferably between 200 m/minute and 1500 m/minute. The extrusion rate is generally between 5 and 25 m/minute.

According to one method of implementing the process of the present invention, the extrusion rate is between 5 and 25 m/minute and the take-up rate is between 300 and 1500 m/minute, while still maintaining the take-up rate/extrusion rate ratio defined above.

As a non-limiting example, the process of the invention may be carried out with a take-up rate set at 800 m/minute for an extrusion rate of 10, 12 or 15 m/minute.

In general, the yarns, fibres and filaments are then further drawn, either hot or cold, for example with a draw ratio of up to 3, or even up to 5.

The spun articles—yarns, fibres or filaments—are produced using standard spinning techniques that may be carried out immediately after polymerization of the matrix, the latter being in the melt state. They may also be produced from granules containing the composition.

The spun articles according to the invention may be subjected to any of the treatments that may be carried out in steps subsequent to the spinning step. In particular, they may be drawn, textured, crimped, heated, twisted, dyed, sized, chopped, etc. These complementary operations may be carried out continuously and integrated after the spinning device or may be carried out as a batch process. The list of operations after spinning has no limiting effect.

The spun articles—yarns, fibres and filaments—obtained by the process of the present invention and possessing the features defined above can be used in very many fields of application thanks to their good physical properties.

The spun articles—yarns, fibres or filaments—of the invention possess remarkable physical properties, considering the low amount of reinforcing fillers that they contain, and especially their good transverse yield strength.

The invention also relates to articles comprising yarns, fibres and/or filaments as described above. The yarns, fibres, filaments according to the invention may be used in woven, knitted or nonwoven form.

Many applications may be envisaged for the spun articles—yarns, fibres and filaments—according to the invention. They may be used, for example, in the fields of filtration, pressing and screen printing, but also for the manufacture of carpets, rugs, mats, etc. The fibres according to the invention are particularly suitable for the manufacture of felts for paper machines and especially for the nonwovens for the paper machine felts used in the paper industry.

The spun articles—yarns, fibres, filaments—according to the invention may also be used as carpet yarns. They may also be used, especially the monofilaments, for obtaining fabrics in the screen printing field, for print transfer or in the filtration field.

The spun articles—yarns, fibres, filaments—of the invention, and especially the multifilaments, may also be used in the manufacture of ropes, particularly climbing ropes, or manufacture of belts, especially conveyer belts.

Finally, the yarns of the invention may be used in the manufacture of nets, particularly fishing nets.

Further details or advantages of the invention will become more clearly apparent from the following examples, which in no way limit the present invention.

### EXAMPLES

### Example 1

### Preparation of α-Zrp Nanoparticles

α-ZrP zirconium phosphate, as prepared in Example 4 of Patent Application WO-A-02/16264, from an aqueous solution of zirconium oxychloride (in the form of powder containing 32.8% ZrO₂) with a ZrO₂ concentration of 2.1 mol/l, was used.

50 ml of hydrochloric acid (Prolabo® 36%, d=1; 19), 50 ml of phosphoric acid (Prolabo® 85%, d=1.695) and 150 ml of deionized water were introduced into a 1-litre reactor with stirring. After the mixture was stirred, 140 ml of the 2.1 M aqueous zirconium oxychloride solution was continuously added at a rate of 5.7 ml/min. The stirring was maintained for one hour after all the zirconium oxychloride solution had been added.

After removing the mother liquors, the precipitate was washed by centrifugation at 4500 rpm, with 1200 ml of phosphoric acid (20 g/L H₃PO₄) and then with deionized water, until a conductivity of 6.5 mS (supernatant) was achieved. A cake of the zirconium-phosphate-based precipitate was obtained.

The cake was then dispersed in 1 litre of 10M aqueous phosphoric acid solution. The dispersion thus obtained was transferred to a 2-litre reactor and then heated to 115° C. This temperature was maintained for 5 hours.

The dispersion obtained was washed by centrifugation with deionized water until a conductivity of less than 1 mS (supernatant) was obtained. The cake from the final centrifugation was redispersed so as to obtain a solids content of close to 20%, the pH of the dispersion being between 1 and 2.

A dispersion of a crystallized compound based on zirconium phosphate with a lamellar structure (transmission electron microscopy (TEM) analysis), the lamellae of which were of hexagonal form with a size ranging between 200 and 500 nm, was obtained. The particles consisted of a stack of approximately parallel plates, the thickness of the stacks along the direction perpendicular to the plates being about 200 nm.

XRD (X-ray diffraction) analysis demonstrated the presence of the Zr(HPO₄)₂ 1H₂O crystal phase, with a solids content of 18.9% by weight, a pH of 1.8 and a conductivity of 8 mS.

The particles were neutralized by adding HMD (hexamethylenediamine). Added to this dispersion was a 70% aqueous HMD solution until a pH of 5 was obtained. The dispersion thus obtained was homogenized using an Ultraturax® homogenizer. The final solids content was adjusted by adding deionized water (solids content 15% by weight).

### Example 2

### Polyamide Compositions Filled with Nanoparticles Based on Hexamethylenediamine-Treated α-Zrp Zirconium Phosphate

A nylon-6 was synthesized from caprolactam using a conventional process, by introducing an aqueous dispersion of α-ZrP particles obtained in Example 1 into the polymerization medium. The proportion of the zirconium-phosphate-based compound introduced was 2% by weight. A polymer containing no nanoparticles (comparative example) was also synthesized.

After polymerization, the polymer was formed into granules. These were is washed in order to remove the residual caprolactam. To do this, the granules were immersed in an excess amount of water at 90° C. for a few hours. The granules were then dried under a low vacuum (<0.5 mbar) for 16 hours at 110° C.

Tensile tests were carried out on extruded rods that had been conditioned for 30 days at 23° C. and a relative humidity of 50%. The diameter of the rods was between 0.5 mm and 1 mm. An INSTRON® 1185 tensile testing machine was used with a 100 N load cell at a pull rate of 50 mm/minute. The nominal stress (ratio of the measured force through the cross section determined by Palmer diameter measurement) as a function of the applied relative deformation. The results are given in Table 1.

TABLE 1

| Compound | Modulus at the | Relative elongation |
|---|---|---|
| introduced | origin (MPa) | at break (%) |
| Example 2 | 1420 | 360 |
| Comparative example | 920 | 320 |

A polyamide-based composition was obtained, the elongation at break of which was greater than that of a polyamide not containing the mineral compound and the modulus of which was improved.

The compositions, obtained as above, comprising nylon-6 and 2% by weight of zirconium-phosphate-based compound, were observed by TEM on sections with a mean thickness of 0.1 μm. The presence of very many dispersed mineral lamellae of nanoscale thickness and a width of 50 to 100 nm was observed.

### Example 3

### Mechanical Properties of the Yarns Obtained According to the Process According to the Invention

### 1) Intention: Elongation at Break and Tensile Strength

Spinning trials were carried out with a nylon-6 filled with HMD-intercalated α-ZrP particles, as prepared in Example 2 above, so as to obtain yarns consisting of 10 filaments. The extrusion rates were set at 12 m/min. The take-up rates varied from 650 m/min to 1100 m/min. A subsequent drawing operation was applied at 140° C. The draw ratio applied between heated rolls for each yarn tested is indicated in Table 2 below. The tensile properties are given in Table 3. These properties were measured with a 10 N load cell for a gauge length of 200 mm, at a pull rate of 200 mm/min, at 23° C. and 50% RH.

TABLE 2
Characteristics of the yarns

| | Draw | Strand linear | Take-up rate | Lamellar filler |
|---|---|---|---|---|
| | ratio | density (dtex) | (m/min) | content (%) |
| Yarn 1 | 2.16 | 9.7 | 800 | 0 |
| Yarn 2 | 2.5 | 8.4 | 800 | 0.2 |
| Yarn 3 | 2.04 | 10.3 | 800 | 0.5 |

TABLE 3
Mechanical properties of the yarns

| | Elongation at break (%) | Tensile strength |
|---|---|---|
| | (23° C.; 50% RH) | (cN/tex) |
| Yarn 1 | 79.6 ± 8.3 | 29.7 ± 2.2 |
| Yarn 2 | 83.7 ± 11.5 | 28.3 ± 2.7 |
| Yarn 3 | 73.7 ± 7.4 | 32.3 ± 2.0 |

### 2) In Compression: Transverse Modulus and Transverse Yield Strength

The transverse compression test carried out on filaments is a transposition down to a small scale of a conventional mechanical test used in civil engineering, the principle of which is the following:

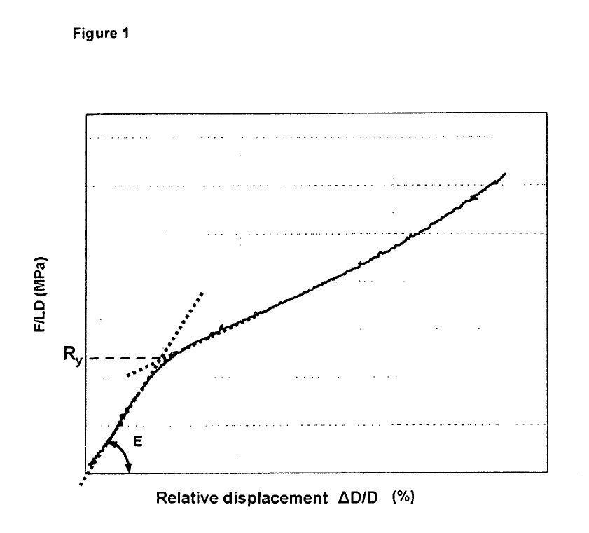

A fibre of diameter D, or a single filament extracted from a yarn, is placed between two surfaces. The axes of said fibre and of said surfaces are parallel. One of the two surfaces is movable and compresses the fibre over a length L with a force F. The result of the test is a conventional curve of the force/displacement type. FIG. 1 shows an example of such a curve. This curve is used to determine firstly the transverse modulus (E) and secondly the transverse yield strength (Ry).

The modulus is determined from the initial linear region. A calculation assumption must be made, namely that Poisson's ratio is fixed at 0.4, whereas it may vary from 0.3 to 0.5. The impact on the calculation of the modulus is very slight. The equation employed for the calculation is the following:

$$E = \frac{\frac{2 F}{LD} \cdot \frac{( 3 + v )}{π}}{\frac{Δ D}{D}} ,$$

in which F represents the force, A D is the measured displacement and v represents Poisson's ratio.

The other quantity determined is the transverse yield strength Ry. This quantity is determined at the centre of the fibre. At this point, stresses coexist in two orthogonal directions. A yield criterion—the von Mises criterion—is therefore used to evaluate the yield strength. Taking into account the stress state, the yield strength Ry is expressed by the following equation:

$${R}_{y} = \frac{{13}^{1 / 2} \cdot 2}{π} \cdot \frac{{F}_{y}}{LD} .$$

This test is of certain benefit in order to understand the behaviour of the fibres in a number of applications: rugs and carpets, and felts used in papermaking in particular.

The variations in the transverse yield strength of the yarns are given in Table 4, as a function of the draw ration and the lamellar filler content. The properties are generally improved when α-ZrP is present.

TABLE 4
Mechanical properties in transverse compression
of a filament extracted from the yarn

| | Transverse | | | | |
|---|---|---|---|---|---|
| | yield | Transverse | | Take-up | Lamellar |
| | strength R_{y} | modulus E | Draw | rate | filler content |
| | (MPa) | (MPa) | ratio | (m/min) | (%) |
| Yarn 1 | 35.4 ± 2.7 | 500 ± 30 | 2.16 | 800 | 0 |
| Yarn 2 | 48.4 ± 6.0 | 480 ± 80 | 2.5 | 800 | 0.2 |
| Yarn 3 | 49.1 ± 1.8 | 650 ± 30 | 2.04 | 800 | 0.5 |

1.-19. (canceled)

20. A yarn, fiber or filament comprising a polyamide matrix in which from 0.01% to 5% by weight of nanoparticles are dispersed and having a transverse yield strength of from 40 to 150 MPa with an elongation at break of from 20% to 140%.

21. The yarn, fiber or filament as defined by claim 20, in which the matrix is a polyamide selected from among nylon-6 (PA-6), nylon-6,6 (PA-6,6), nylon-6/6,6 copolymer, or blend in any proportions of two or more thereof.

23. The yarn, fiber or filament as defined by claim 20, having a strand linear density of from 1.9 to 130 dtex.

24. The yarn, fiber or filament as defined by claim 20, in which the nanoparticles comprise lamellar fillers having an aspect ratio of not less than 3.

25. The yarn, fiber or filament as defined by claim 20, in which the smallest particle dimension of said nanoparticles is on the order of one nanometer to a few tens of nanometers.

26. The yarn, fiber or filament as defined by claim 20, in which the nanoparticles dispersed in the polyamide matrix have an aspect ratio of from 4 to 1,000 and the smallest particle dimension thereof is 100 nm or less.

27. The yarn, fiber or filament as defined by claim 20, in which the nanoparticles are selected from among mica phyllosilicates and exfoliated oxides, sulfides or phosphates of metals or non-metals.

28. The yarn, fiber or filament as defined by claim 20, in which the nanoparticles are selected from among clays and zirconium phosphate, optionally in alpha (“α-ZrP”) crystalline form.

29. The yarn, fiber or filament as defined by claim 20, comprising a polyamide matrix in which from 0.01 to 1% by weight of zirconium phosphate nanoparticles are dispersed, these optionally being in the alpha (“α-ZrP”) crystalline form.

30. A process for the preparation of a yarn, fiber or filament as defined by claim 20, comprising melt-spinning a filled composition which comprises at least one polyamide matrix in which from 0.01 to 5% by weight of nanoparticles are dispersed, the take-up rate/extrusion rate ratio thereof ranging from 20 to 300.

31. The process as defined by claim 30, wherein the take-up rate ranges from 150 m/minute to 2000 m/minute.

32. The process as defined by claim 31, wherein the extrusion rate ranges from 5 to 25 m/minute.

33. The process as defined by claim 32, carried out at a take-up rate set at about 800 m/minute for an extrusion rate of 10, 12 or 15 m/minute.

34. A shaped article comprising a yarn, fiber and/or filament as defined by claim 20.

35. The shaped article as defined by claim 34, comprising a felt for a paper machine.

36. The shaped article as defined by claim 34, comprising a carpet, rug or mat.

37. The shaped article as defined by claim 34, comprising a rope or a belt.

38. The shaped article as defined by claim 34, comprising a woven fabric for transfer or for filtration.

39. The shaped article as defined by claim 34, comprising a net.

40. The yarn, fiber or filament as defined by claim 20, said polyamide matrix having a transverse yield strength of from 45 to 95 MPa with an elongation at break of from 40% to 100%.

41. The yarn, fiber or filament as defined by claim 20, having a strand linear density of from 1.9 to 66 dtex.

42. The yarn, fiber or filament as defined by claim 20, said nanoparticles comprising lamellar fillers having an aspect ratio of from 5 to 500.
